(19) United States
(12) Patent Application Publication
(10) Pub. No.: US 2017/0180396 A1
(43) Pub. Date: Jun. 22, 2017

(54) Evasive Intrusion Detection in Private Network

(71) Applicant: F-Secure Corporation, Helsinki (FI)

(72) Inventors: Marko Finnig, Helsinki (FI); Erka Koivunen, Helsinki (FI)

(73) Assignee: F-Secure Corporation

(21) Appl. No.: 15/381,274

(22) Filed: Dec. 16, 2016

(30) Foreign Application Priority Data
Dec. 18, 2015 (GB) 1522364.7

(51) Int. Cl. H04L 29/06

(52) U.S. Cl. CPC H04L 63/1408

(57) ABSTRACT

There are provided measures for enabling evasive intrusion detection in a private network. Such measures could exemplarily include a system for intrusion detection in a private network, said private network including a plurality of endpoints and an endpoint security system for monitoring security of the plurality of endpoints, said system including an intrusion scanning entity for scanning the plurality of endpoints in the private network for indications of an intrusion from outside of the private network, and an intrusion notifying entity for collecting intrusion scanning information for the plurality of endpoints in the private network from the intrusion scanning entity, wherein the intrusion scanning entity and the intrusion notifying entity are set up uniquely for the private network on the basis of intrusion suspicion information from the endpoint security system.

### FIELD

The present invention relates to evasive intrusion detection in a private network. More specifically, the present invention relates to measures (including methods, apparatuses and computer program products) for enabling evasive intrusion detection in a private network.

### BACKGROUND

In modern communication networks, security is a vital issue, and attacks on network security tend to be increasing in terms of both number and complexity. Accordingly, especially in private networks (such as internal networks of companies and other institutions, etc.), applying proper intrusion detection and threat response is paramount in modern communication networks.

When an intrusion from outside of a private network is suspected, e.g. as a result of security monitoring by an endpoint security system or the like in the private network, it is sometimes preferential to avoid that the attacker gets aware of being discovered in terms of intrusion efforts. Namely, in order to gather proper evidence for the suspected intrusion, the operator of the private network must not alert the attacker so as to prevent the attacker from covering his tracks, i.e. clean the attacked system (e.g. any endpoints in the private network) from any evidence of the attack. Accordingly, the operator of the private network in which intrusion is suspected wishes to or even shall refrain from using its endpoint security system or the like, since such existing security solutions could already be compromised and are typically “noisy” in the meaning that their activity can be observed by the attacker.

The above-outlined scenario is generally applicable, but is especially expedient in the case of so-called Advanced Persistent Threats (APTs), as in this case, generally, the attacker has invested lots of efforts in the preparation and execution of the attack and already has a plan to quickly cover his tracks when getting discovered. Hence, any institutions at risk of being targeted by APT will want to follow strict operational security procedures when investigating initial signs of security anomalies. Accordingly, there is a pronounced need for an automated technique so as to hide the fact that an investigation is taking place in the first place from the attacker.

Further, the operator of the private network in which intrusion is suspected wishes to or even shall refrain from reporting any indications or information of its intrusion suspicion to any external location, e.g. to a security provider which could support intrusion detection in the private network, since such data transfer could be intercepted/listened by the attacker. That is, the operator of the private network in which intrusion is suspected preferably ensures complete “radio silence” as regards its intrusion suspicion.

Hence, there is a need for a technique of evasive intrusion detection in a private network. That is, there is a need for a technique enabling intrusion detection in a private network, which is “silent” or “hidden” in the meaning that its presence and activity cannot be (easily) observed nor recognized by the attacker, even if at least some parts of the private network system is already compromised and/or controlled by the attacker.

### SUMMARY

Various exemplifying embodiments of the present invention aim at addressing at least part of the above issues and/or problems.

Various aspects of exemplifying embodiments of the present invention are set out in the appended claims.

According to an example aspect of the present invention, there is provided a system for intrusion detection in a private network, said private network comprising a plurality of endpoints and an endpoint security system for monitoring security of the plurality of endpoints, said system comprising: an intrusion scanning entity for scanning the plurality of endpoints in the private network for indications of an intrusion from outside of the private network, and an intrusion notifying entity for collecting intrusion scanning information for the plurality of endpoints in the private network from the intrusion scanning entity, wherein the intrusion scanning entity and the intrusion notifying entity are set up uniquely for the private network on the basis of intrusion suspicion information from the endpoint security system.

According to an example aspect of the present invention, there is provided a method of intrusion detection in a private network, said private network comprising a plurality of endpoints and an endpoint security system for monitoring security of the plurality of endpoints, said method comprising: setting up an intrusion scanning entity and an intrusion notifying entity uniquely for the private network on the basis of intrusion suspicion information from the endpoint security system, deploying the intrusion scanning entity and the intrusion notifying entity in the private network, operating the intrusion scanning entity to scan the plurality of endpoints in the private network for indications of an intrusion from outside of the private network, and report any identified intrusion indication as intrusion scanning information to the intrusion notifying entity, and operating the intrusion notifying entity to collect the intrusion scanning information for the plurality of endpoints in the private network from the intrusion scanning entity, and notify the collected intrusion scanning information to an operator of the private network or a security provider.

According to further developments and/or modifications of any one of the aforementioned example aspects of the present invention, for example, one or more of the following can apply:
the intrusion suspicion information may comprise at least one indicator of compromise of a suspected intrusion in the private network and/or at least one rule for detection of a suspected intrusion in the private network, wherein the suspected intrusion may be monitored by the endpoint security system,
the intrusion scanning information may comprise information on which one or more endpoints are compromised by the intrusion and/or information on which one or more kinds of compromise are used by the intrusion,
the intrusion scanning entity and the intrusion notifying entity may be created as client and server software packages, respectively,
the intrusion scanning entity and the intrusion notifying entity may be configured by running their build scripts using the intrusion suspicion information, respectively,
the intrusion scanning entity and the intrusion notifying entity may be uniquely created by a security provider on the basis of system information of the private network and/or the intrusion suspicion information,
the intrusion scanning entity and the intrusion notifying entity may be configured by an operator of the private network on the basis of the intrusion suspicion information,
the intrusion scanning entity may be deployed and operated as an agentless client in any one of the plurality of endpoints in the private network,
the intrusion notifying entity may be deployed and operated as a server in a dedicated host in the private network,
the intrusion scanning entity may be deployed in any endpoint at an arbitrary location in the endpoint, which is different from a standard location for installation of a security-related client or agent,
the intrusion notifying entity may be deployed in the dedicated host at an arbitrary location in the private network, which is different from a standard location for implementation of a security-related server,
the intrusion scanning entity may be deployed and operated upon verification that the intrusion scanning entity and/or the intrusion notifying entity is not identified and/or flagged as malicious by the endpoint security system in the private network,
the intrusion scanning entity may scan the plurality of endpoints in the private network for indications of an intrusion from outside of the private network, and may report any identified intrusion indication as intrusion scanning information to the intrusion notifying entity,
the intrusion notifying entity may collect the intrusion scanning information for the plurality of endpoints in the private network from the intrusion scanning entity, and may notify the collected intrusion scanning information to an operator of the private network or a security provider,
the intrusion scanning entity, after scanning and reporting, may automatically delete itself and clean any indication of its presence from any one of the plurality of endpoints in the private network.

According to an example aspect of the present invention, there is provided a computer program product, comprising computer-executable computer program code which, when the computer program code is executed on a computer, is configured to realize the system according to the aforementioned system-related example aspect of the present invention, an/or to cause the computer to carry out a method according to the aforementioned method-related example aspect of the present invention, including any developments and/or a modifications thereof.

The computer program product may comprise or may be embodied as a (tangible/non-transitory) computer-readable (storage) medium or the like, on which the computer-executable computer program code is stored, and/or the program is directly loadable into an internal memory of the computer or a processor thereof.

Further developments and/or modifications of the aforementioned example aspects of the present invention are set out herein with reference to. the drawings and exemplifying embodiments of the present invention.

By way of exemplifying embodiments of the present invention, realization of evasive intrusion detection in a private network is enabled, which is capable of detection private network intrusion in a “silent” or “hidden” manner, i.e. such that its presence and activity cannot be (easily) observed nor recognized by an attacker, even if at least some parts of the private network system is already compromised and/or controlled by the attacker.

### BRIEF DESCRIPTION OF THE DRAWINGS

In the following, the present invention will be described in greater detail by way of non-limiting examples with reference to the accompanying drawings, in which

FIG. 1 shows a schematic diagram illustrating a system configuration underlying exemplifying embodiments of the present invention,

FIG. 2 shows a flowchart illustrating an example of a method according to exemplifying embodiments of the present invention,

FIG. 3 shows a process diagram illustrating an example of a use case according to exemplifying embodiments of the present invention, and

FIG. 4 shows a schematic diagram illustrating an example of a structure of an apparatus according to exemplifying embodiments of the present invention.

### DETAILED DESCRIPTION

The present invention is described herein with reference to particular non-limiting examples and to what are presently considered to be conceivable embodiments of the present invention. A person skilled in the art will appreciate that the present invention is by no means limited to these examples, and may be more broadly applied.

Hereinafter, various exemplifying embodiments and implementations of the present invention and its aspects are described using several variants and/or alternatives. It is generally noted that, according to certain needs and constraints, all of the described variants and/or alternatives may be provided alone or in any conceivable combination (also including combinations of individual features of the various variants and/or alternatives). In this description, the words “comprising” and “including” should be understood as not limiting the described exemplifying embodiments and implementations to consist of only those features that have been mentioned, and such exemplifying embodiments and implementations may also contain features, structures, units, modules etc. that have not been specifically mentioned.

In the drawings, it is noted that lines/arrows interconnecting individual blocks or entities are generally meant to illustrate an operational coupling there-between, which may be a physical and/or logical coupling, which on the one hand is implementation-independent (e.g. wired or wireless) and on the other hand may also comprise an arbitrary number of intermediary functional blocks or entities not shown.

According to exemplifying embodiments of the present invention, in general terms, there are provided measures and mechanisms for enabling evasive intrusion detection in a private network, as described in more details below.

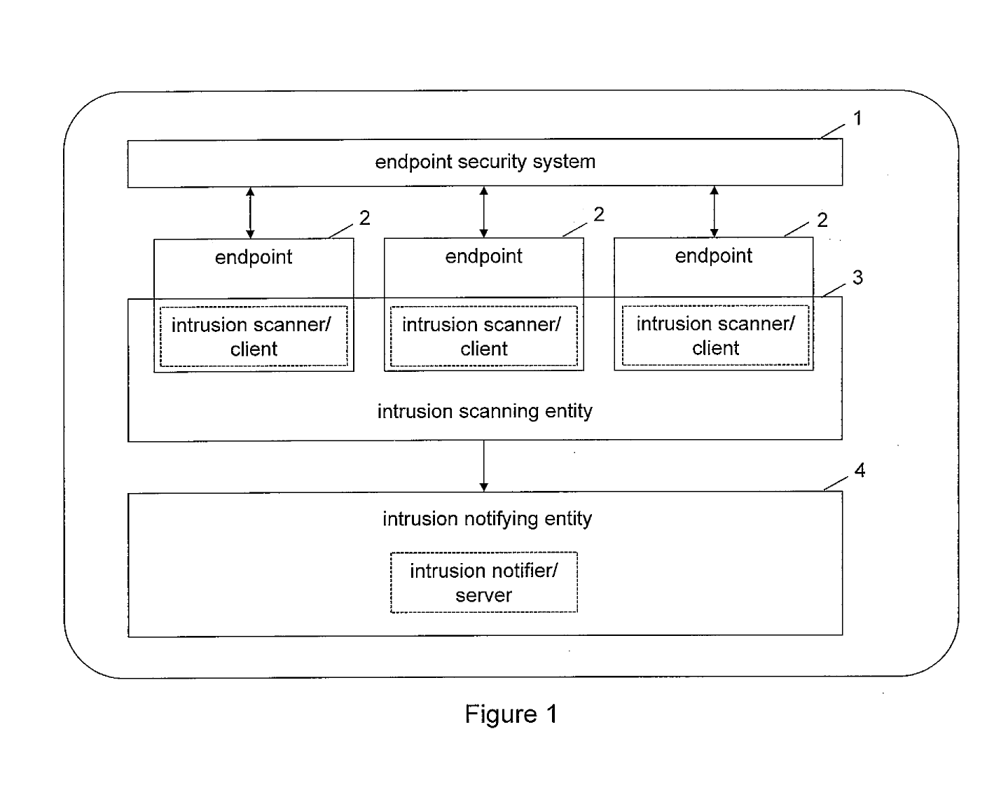

FIG. 1 shows a schematic diagram illustrating a system configuration underlying exemplifying embodiments of the present invention.

As shown in FIG. 1, exemplifying embodiments of the present invention are generally based on a system environment of a private network (such as internal networks of companies and other institutions, etc.), as indicated by a block with rounded corners.

The private network comprises an endpoint security system 1 and a plurality of endpoints 2, wherein the endpoint security system is configured to monitor security of the plurality of endpoints. In the present specification, an endpoint is intended to represent any kind of network node or host, including laptops, desktops, mobiles, servers, or the like. It is to be noted that the endpoint security system is illustrated as a non-limiting example of any network security system installed in the private network (before deployment of an evasive intrusion detection system according to exemplifying embodiments of the present invention).

In addition thereto, the private network comprises an evasive intrusion detection system according to exemplifying embodiments of the present invention. Such evasive intrusion detection system comprises an intrusion scanning entity 3 and an intrusion notifying entity 4. As indicated by dashed boxes, the intrusion scanning entity 3 can include or be realized by an intrusion scanner (client) in any one of the endpoints, and the intrusion notifying entity 4 can include or be realized by an intrusion notifier (server).

The intrusion scanning entity 3 is configured to scan the plurality of endpoints in the private network for indications of an intrusion from outside of the private network, and the intrusion notifying entity 4 is configured to collect intrusion scanning information for the plurality of endpoints in the private network from the intrusion scanning entity. Such collected intrusion scanning information can then be used for any purpose, e.g. for notifying an operator or administrator, or the like.

The intrusion scanning entity 3 and the intrusion notifying entity 4 are set up uniquely for the private network on the basis of intrusion suspicion information from the endpoint security system 2, i.e. in response to a suspected intrusion monitored by the endpoint security system 2.

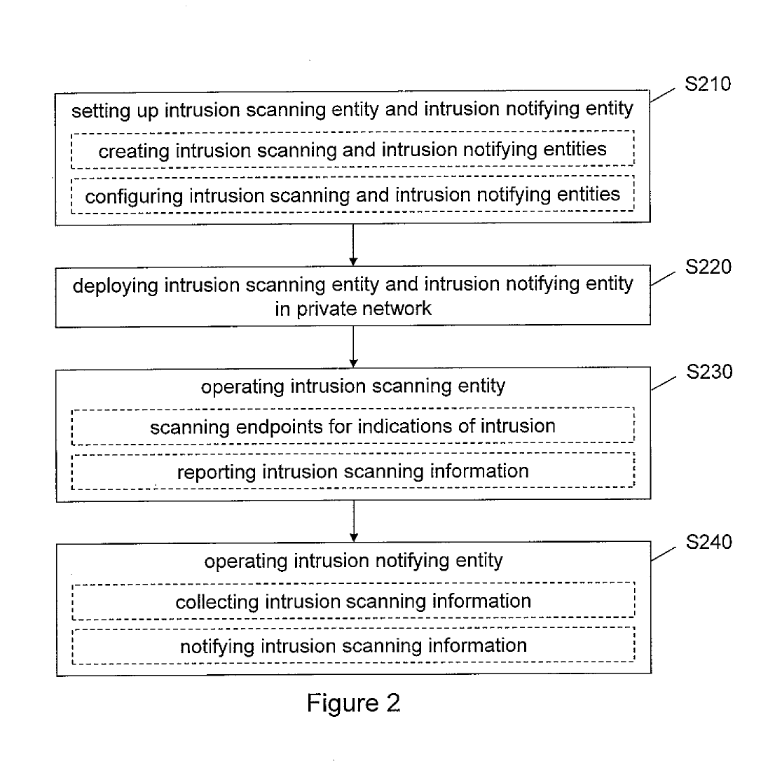

FIG. 2 shows a flowchart illustrating an example of a method according to exemplifying embodiments of the present invention. Such method is operable in the system environment of the private network illustrated in FIG. 1.

According to exemplifying embodiments of the present invention, the method of FIG. 2 can be initiated upon monitoring of a suspected intrusion in the private network by the endpoint security system, i.e. when the endpoint security system provides some sort of intrusion suspicion information. The method of FIG. 2 basically comprises (an operation of) setting up the intrusion scanning entity and the intrusion notifying entity uniquely for the private network on the basis of the intrusion suspicion information from the endpoint security system (S210), (an operation of) deploying the intrusion scanning entity and the intrusion notifying entity in the private network (S220), (an operation of) operating the intrusion scanning entity (S230), and (an operation of) operating the intrusion notifying entity (S240).

Herein, the intrusion suspicion information can comprise e.g. at least one indicator of compromise (IoC) of a suspected intrusion in the private network and/or at least one rule for detection of a suspected intrusion in the private network, wherein the suspected intrusion is monitored by the endpoint security system. The indicator of compromise (IoC) is a technical (often machine-parseable) description of an existing breach/intrusion/method/artefact/etc. that can be used to identify the incident. The IoC may be monitored by the endpoint security system, and may comprise e.g. signatures such as virus/malware signatures, addresses such as IP addresses, hashes such as MD5 hashes of malware/virus files or URLs or domain names, or the like. The rules may be based on the monitoring of the endpoint security system, and may comprise e.g. YARA rules.

According to exemplifying embodiments of the present invention, the set-up (operation) can comprise creating the intrusion scanning entity and the intrusion notifying entity as client and server software packages, and configuring the intrusion scanning entity and the intrusion notifying entity by running their build scripts using the intrusion suspicion information.

First, the operator of the private network instructs a security provider with such creation, and the security provider thus creates unique client and server software packages on the basis of system information of the private network and/or the intrusion suspicion information of the suspected intrusion.

Then, the security provider provides the thus created unique client and server software packages to the operator of the private network, and the operator of the private network configures the unique client and server software packages on the basis of the intrusion suspicion information. Running the build scripts of the client and server software packages enables attachment of the intrusion suspicion information for configuration purposes. That is, the operator of the private network can locally customize the client and server software packages from the security provider using its own knowledge/suspicion on the attack on its private network. For example the operator of the private network can locally feed the obtained client and server software packages with proprietary IoCs. Hence, the operator of the private network does not need to send any indications or information of its intrusion suspicion to any external location, e.g. to the security provider.

Herein, uniqueness of the intrusion scanning entity and the intrusion notifying entity, such as the client and server software packages, means that they are tailor-made with respect to the private network and its components upon demand, i.e. no standard or prior-used entities or software is used. That is, the incarnation of the tool (i.e. the incarnations of the client and server software packages) is unique and something the attacker cannot expect or predict. Thereby, when being deployed in the private network, they are hidden from the attacker (i.e. not readily recognizable), since the attacker does not have any knowledge which could be similar to or facilitate recognition of such uniquely set-up entities or software packages. In this meaning, the client and server software packages according to exemplifying embodiments of the present invention can be said to “evade” the attacker or the attacker's provisions/measures for recognizing that investigation with regard to his attack is taking place.

For example, such uniqueness can be attained, when such uniquely set-up entities or software packages always use different process names, executable names, data exchange methods, or the like. Such variability e.g. in terms of a change of process names, executable names, data exchange methods, or the like could be realized between distinct instances of entities or software packages (i.e. entities or software packages for different clients or orders are designed to employ—constantly—mutually different process names, executable names, data exchange methods, or the like) or within a single instance of entities or software packages (i.e. entities or software packages for the same client or order are designed to change—during operation—process names, executable names, data exchange methods, or the like e.g. in a temporal, periodical, continuous, predefined, trigger manner based on some programming). That is, uniqueness can be ensured by way of design or preconfiguration or by way of variable/changing operation.

According to exemplifying embodiments of the present invention, the deployment (operation) can comprise that the intrusion scanning entity is deployed and operated as an agentless client in any one of the plurality of endpoints in the private network, and the intrusion notifying entity is deployed and operated as a server in a dedicated host in the private network. For example, the intrusion scanning entity is deployed in any endpoint at an arbitrary location in the endpoint, which is different from a standard location for installation of a security-related client or agent, and/or the intrusion notifying entity is deployed in the dedicated host at an arbitrary location in the private network, which is different from a standard location for implementation of a security-related server. Thereby, the intrusion scanning entity and the intrusion notifying entity are hidden from the attacker, since the attacker does not have any knowledge which could help discovering such deployed entities; all the more, as the utilized locations are different from the expected (standard) locations in this regard. That is to say, it is beneficial for the operator of the private network to refrain from following standard installation and/or implementation measures or routines.

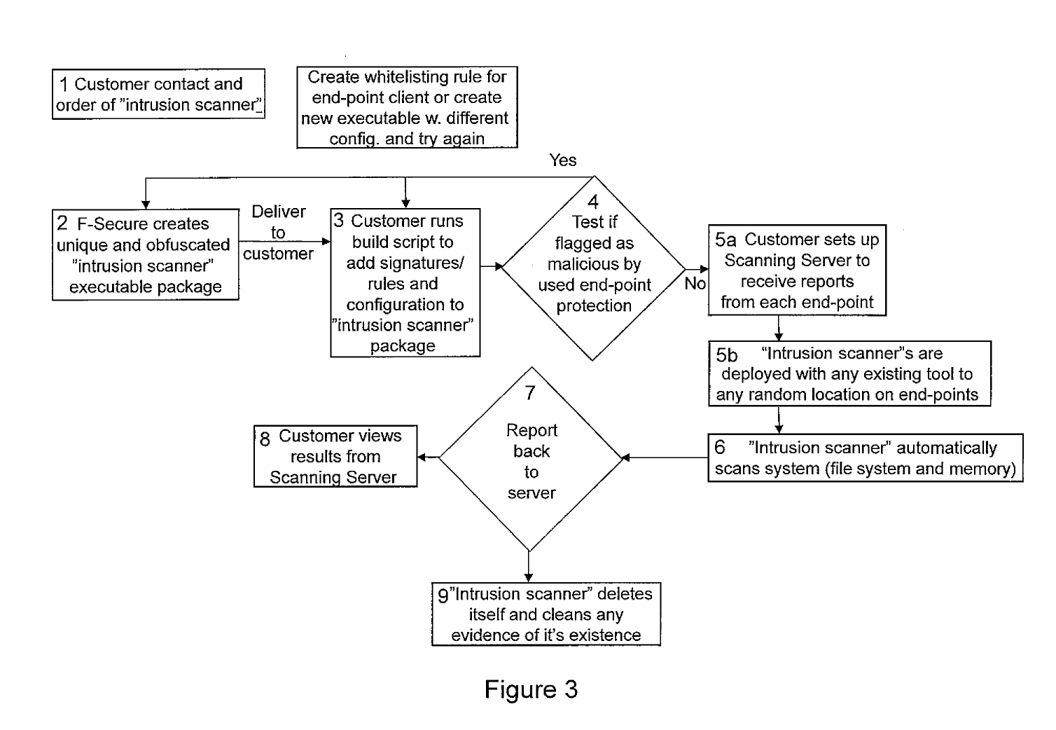

Optionally, the intrusion scanning entity and/or the intrusion notifying entity is deployed and operated only upon verification that the intrusion scanning entity is not identified and/or flagged as malicious by the endpoint security system in the private network. Details in this regard are given in connection with FIG. 3 below.

According to exemplifying embodiments of the present invention, the intrusion scanning entity, e.g. the intrusion scanner (client) in any endpoint, can operate to perform scanning of the plurality of endpoints in the private network for indications of an intrusion from outside of the private network, and reporting any identified intrusion indication as intrusion scanning information to the intrusion notifying entity.

According to exemplifying embodiments of the present invention, the intrusion notifying entity, e.g. the intrusion server, can operate to perform collecting the intrusion scanning information for the plurality of endpoints in the private network from the intrusion scanning entity, and notifying the collected intrusion scanning information to an operator of the private network or a security provider.

FIG. 3 shows a process diagram illustrating an example of a use case according to exemplifying embodiments of the present invention. The thus exemplified use case constitutes an example of an application of the principles set forth in connection with FIGS. 1 and 2 above.

In the thus exemplified use case, it is presumed that “F-Secure” represents a security provider, and “customer” represents an operator of a private network in which intrusion is suspected. The process is basically described from the perspective of “F-Secure”.

In phase (1), the customer contacts the security provider with an indication that they have a suspicion of intrusion, i.e. a suspicion that at least some part of the private network is compromised and/or controlled by the attacker. Such indication does not need to be but could optionally also include information on who the attacker is (deemed/estimated to be) and/or what malware or the like is (deemed/estimated to be) used in the intrusion attack. Specifically, when the customer is looking for signs of intrusion in his own domain of control, i.e. the private network, there is no need to involve additional third parties in the circulation of intrusion suspicion information such as IoCs at this phase. In this regard, the order of an “intrusion scanner” is meant to refer to an overall evasive intrusion detection system comprising an intrusion scanning entity and an intrusion notifying entity.

In phase (2), the security provider creates a unique agentless client scanner software package for the endpoints of the private network and a server software package to collect the data from the scans of the endpoints, and delivers these software packages to the customer. Both the client “intrusion scanner” and the server are unique to hide them from the attacker. For example, they always use different process names, executable names, data exchange methods, or the like, as explained above.

In phase (3), the customer runs a build script to attach the needed intrusion suspicion information, such as e.g. at least one Indicator of Compromise (IoC) signatures and/or at least one YARA rule, to the client and server software packages. Such intrusion suspicion information could be gathered by the customer itself (e.g. using its existing endpoint security system or the like) or be provided to the customer by any external party having such information.

In phase (4), the customer tests the deployment to make sure the client and/or server software package, when deployed in the private network, is not flagged as malicious by the endpoint security system of the like in the private network. If so, for example, the security provider can create new package/s, or the customer can change whitelisting rules Of the endpoint security system of the like in the private network.

In phase (5a), the customer deploys the agentless intrusion scanner to all of the endpoints in the private network, and, in phase (5b), the customer deploys the server in the private network. For any one of both deployments, a random location should be used, as the client is agentless (no standard installation used), to make it difficult for the attacker to notice the presence of the scanner and the server.

In phase (6), each of the intrusion scanners scans the file system and the memory of its endpoint (where it is deployed) according the given intrusion suspicion information, such as e.g. IoC/s or rule/s. Generally speaking, findings on potential intrusion are acquired in this phase. Namely, any intrusion and/or attacker's activity could be detected e.g. through means of enumerating local system resources and searching for traces of known malicious activity.

In phase (7), the intrusion scanner reports the findings on potential intrusion back to the server. Such findings can involve information on which one or more endpoints are compromised and/or attacker-controlled by the intrusion and/or information on which one or more kinds of compromise are used by the intrusion. Various kinds of compromise can involve, for example, one or more of virus/malware, attacking address, malware/virus files, or URLs or domain names, or the like.

In phase (8), the intrusion scanner deletes itself and cleans any indication of its presence (so as to hide from later recognition by the attacker). That is, the intrusion scanning entity, after scanning and reporting, can automatically delete itself and clean any indication of its presence from any one of the plurality of endpoints in the private network.

In phase (9), the customer can then view the results from the server to see what the result is and what the compromised and/or attacker-controlled endpoint/s is/are. Additionally or alternatively, the findings on potential intrusion can be used for any other purpose as well.

In the above-outlined process, it can be considered that phases (1) to (4) basically relate to operation S210 in FIG. 2, phase (5) basically relates to operation 5220 in FIG. 2, phases (6) to (8) basically relate to operation S230 in FIG. 2, and phase (9) basically relates to operation S240 in FIG. 2.

It is to be noted that the above-outlined process of a use case for the application of the principles set forth in connection with FIGS. 1 and 2 above is given for illustrative purposes only, and it is by no way intended to restrict the exemplary embodiments of the present invention, as described herein.

By virtue of exemplifying embodiments of the present invention, as described above, evasive intrusion detection in a private network is enabled, which is capable of detection private network intrusion in a “silent” or “hidden” manner, i.e. such that its presence and activity cannot be (easily) observed nor recognized by an attacker, even if at least some parts of the private network system is already compromised and/or controlled by the attacker.

Namely, the evasive intrusion detection system according to exemplifying embodiments of the present invention basically exhibits one or more of the following features: it is implemented in parallel with an existing security solution in the private network, it is based on unique intrusion scanning and intrusion notifying entities specifically created for the present case of suspected intrusion in the private network in question, the intrusion scanning entity is operable in an agentless manner, and it is customized using recent intrusion suspicion information for the present case of suspected intrusion in the private network in question. Accordingly, it can be achieved that the thus implemented evasive intrusion detection system is effective in detecting the suspected intrusion (i.e. the endpoint/s concerned and the kind of compromise applied), and its presence and activity can hardly be observed/recognized by the attacker.

Accordingly, it could be said that exemplifying embodiments of the present invention present an easy-to-use tool (Le. client and server software packages) that will allow network operators to scan the endpoints in their private network, find the applied compromise such as malware in the private network, and remain hidden to the attacker so they will not be alerted to clean the system from any evidence of their presence. Such tool can be utilized both by the network operator and the security provider.

The above-described methods, procedures and functions may be implemented by respective functional elements, entities, modules, units, processors, or the like, as described below.

While in the foregoing exemplifying embodiments of the present invention are described mainly with reference to methods, procedures and functions, corresponding exemplifying embodiments of the present invention also cover respective apparatuses, entities, modules, units, nodes and systems, including both software and/or hardware thereof.

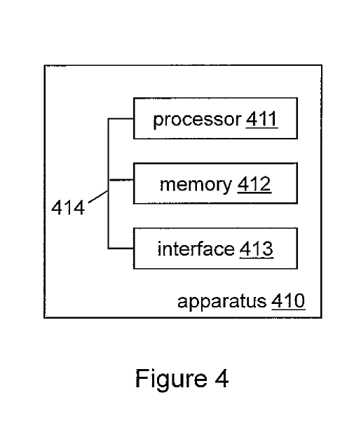

Respective exemplifying embodiments of the present invention are described below referring to FIG. 4, while for the sake of brevity reference is made to the detailed description of respective corresponding configurations/setups, schemes, methods and functionality, principles and operations according to FIGS. 1 to 3.

In FIG. 4, the solid line blocks are basically configured to perform respective methods, procedures and/or functions as described above. The entirety of solid line blocks are basically configured to perform the methods, procedures and/or functions as described above, respectively. With respect to FIG. 4, it is to be noted that the individual blocks are meant to illustrate respective functional blocks implementing a respective function, process or procedure, respectively. Such functional blocks are implementation-independent, i.e. may be implemented by means of any kind of hardware or software or combination thereof, respectively.

Further, in FIG. 4, only those functional blocks are illustrated, which relate to any one of the above-described methods, procedures and/or functions. A skilled person will acknowledge the presence of any other conventional functional blocks required for an operation of respective structural arrangements, such as e.g. a power supply, a central processing unit, respective memories, a display, or the like. Among others, one or more memories are provided for storing programs or program instructions for controlling or enabling the individual functional entities or any combination thereof to operate as described herein in relation to exemplifying embodiments.

In general terms, respective devices/apparatuses (and/or parts thereof) may represent means for performing respective operations and/or exhibiting respective functionalities, and/or the' respective devices (and/or parts thereof) may have functions for performing respective operations and/or exhibiting respective functionalities.

In view of the above, the thus illustrated devices/apparatuses are suitable for use in practicing one or more of the exemplifying embodiments of the present invention, as described herein.

FIG. 4 shows a schematic diagram illustrating an example of a structure of an apparatus according to exemplifying embodiments of the present invention.

As indicated in FIG. 4, an apparatus 410 according to exemplifying embodiments of the present invention may comprise at least one processor 411 and at least one memory 412 (and possibly also at least one interface 413), which may be operationally connected or coupled, for example by a bus 414 or the like, respectively.

The processor 411 of the apparatus 410 is configured to read and execute computer program code stored in the memory 412. The processor may be represented by a CPU (Central Processing Unit), a MPU (Micro Processor Unit), etc, or a combination thereof. The memory 412 of the apparatus 410 is configured to store computer program code, such as respective programs, computer/processor-executable instructions, macros or applets, etc. or parts of them. Such computer program code, when executed by the processor 411, enables the apparatus 410 to operate in accordance with exemplifying embodiments of the present invention. The memory 412 may be represented by a RAM (Random Access Memory), a ROM (Read Only Memory), a hard disk, a secondary storage device, etc., or a combination of two or more of theses. The interface 413 of the apparatus 410 is configured to interface with another apparatus and/or the user of the apparatus 610.

That is, the interface 413 may represent a communication interface (including e.g. a modem, an antenna, a transmitter, a receiver, a transceiver, or the like) and/or a user interface (such as a display, touch screen, keyboard, mouse, signal light, loudspeaker, or the like).

The apparatus 410 may, for example, represent an endpoint on which an intrusion scanning entity is deployed and/or operated, or a network node or host on which an intrusion notifying entity is deployed and/or operated. Also, the apparatus 410 may, for example, represent any computer on which functions for set-up and/or deployment of the intrusion scanning entity and/or the intrusion notifying entity can be carried out or controlled.

Accordingly, any one of the above-described schemes, methods, procedures, principles and operations may be realized in a computer-implemented manner.

Any apparatus according to exemplifying embodiments of the present invention may be structured by comprising respective units or means for performing corresponding operations, procedures and/or functions. For example, such means may be implemented/realized on the basis of an apparatus structure, as exemplified in FIG. 4 above, i.e. by one or more processors 411, one or more memories 412, one or more interfaces 413, or any combination thereof.

For further details regarding the operability/functionality of individual apparatuses according to exemplifying embodiments of the present invention, reference is made to the above description in connection with any one of FIGS. 1 to 3, respectively.

According to exemplifying embodiments of the present invention, any one of the processor, the memory and the interface may be implemented as individual modules, chips, chipsets, circuitries or the like, or one or more of them can be implemented as a common module, chip, chipset, circuitry or the like, respectively.

According to exemplifying embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or units, means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible or non-transitory medium such as a computer-readable (storage) medium having stored thereon a respective data structure or code means/portions or embodied in a signal or in a chip, potentially during processing thereof. A computer program product encompasses a computer memory encoded with executable instructions representing a computer program for operating/driving a computer connected to a network.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for enabling evasive intrusion detection in a private network. Such measures could exemplarily comprise a system for intrusion detection in a private network, said private network comprising a plurality of endpoints and an endpoint security system for monitoring security of the plurality of endpoints, said system comprising: an intrusion scanning entity for scanning the plurality of endpoints in the private network for indications of an intrusion from outside of the private network, and an intrusion notifying entity for collecting intrusion scanning information for the plurality of endpoints in the private network from the intrusion scanning entity, wherein the intrusion scanning entity and the intrusion notifying entity are set up uniquely for the private network on the basis of intrusion suspicion information from the endpoint security system.

Even though the invention is described above with reference to the examples and exemplifying embodiments with reference to the accompanying drawings, it is to be understood that the present invention is not restricted thereto. Rather, it is apparent to those skilled in the art that the above description of examples and exemplifying embodiments is for illustrative purposes and is to be considered to be exemplary and non-limiting in all respects, and the present invention can be modified in many ways without departing from the scope of the inventive idea as disclosed herein.

1. A system for intrusion detection in a private network, said private network comprising a plurality of endpoints and an endpoint security system for monitoring security of the plurality of endpoints, said system comprising:
an intrusion scanning entity for scanning the plurality of endpoints in the private network for indications of an intrusion from outside of the private network, and
an intrusion notifying entity for collecting intrusion scanning information for the plurality of endpoints in the private network from the intrusion scanning entity,
wherein the intrusion scanning entity and the intrusion notifying entity are set up uniquely for the private network on the basis of intrusion suspicion information from the endpoint security system.

2. The system according to claim 1, wherein
the intrusion suspicion information comprises at least one indicator of compromise of a suspected intrusion in the private network and/or at least one rule for detection of a suspected intrusion in the private network, wherein the suspected intrusion is monitored by the endpoint security system.

3. The system according to claim 1, wherein
the intrusion scanning information comprises information on which one or more endpoints are compromised by the intrusion and/or information on which one or more kinds of compromise are used by the intrusion.

4. The system according to claim 1, wherein
the intrusion scanning entity and the intrusion notifying entity are created as client and server software packages, and are configured by running their build scripts using the intrusion suspicion information, respectively.

5. The system according to claim 1, wherein
the intrusion scanning entity and the intrusion notifying entity are uniquely created by a security provider on the basis of system information of the private network and/or the intrusion suspicion information.

6. The system according to claim 1, wherein
the intrusion scanning entity and the intrusion notifying entity are configured by an operator of the private network on the basis of the intrusion suspicion information.

7. The system according to claim 1, wherein
the intrusion scanning entity is deployed and operated as an agentless client in any one of the plurality of endpoints in the private network, and
the intrusion notifying entity is deployed and operated as a server in a dedicated host in the private network.

8. The system according to claim 7, wherein
the intrusion scanning entity is deployed in any endpoint at an arbitrary location in the endpoint, which is different from a standard Location for installation of a security-related client or agent, and/or
the intrusion notifying entity is deployed in the dedicated host at an arbitrary location in the private network, which is different from a standard location for implementation of a security-related server.

9. The system according to claim 7, wherein
the intrusion scanning entity is deployed and operated upon verification that the intrusion scanning entity and/or the intrusion notifying entity is not identified and/or flagged as malicious by the endpoint security system in the private network.

10. The system according to claim 7, wherein
the intrusion scanning entity scans the plurality of endpoints in the private network for indications of an intrusion from outside of the private network, and reports any identified intrusion indication as intrusion scanning information to the intrusion notifying entity, and
the intrusion notifying entity collects the intrusion scanning information for the plurality of endpoints in the private network from the intrusion scanning entity, and notifies the collected intrusion scanning information to an operator of the private network or a security provider.

11. The system according to claim 1, wherein
the intrusion scanning entity, after scanning and reporting, automatically deletes itself and cleans any indication of its presence from any one of the plurality of endpoints in the private network.

12. A method of intrusion detection in a private network, said private network comprising a plurality of endpoints and an endpoint security system for monitoring security of the plurality of endpoints, said method comprising:
setting up an intrusion scanning entity and an intrusion notifying entity uniquely for the private network on the basis of intrusion suspicion information from the endpoint security system,
deploying the intrusion scanning entity and the intrusion notifying entity in the private network,
operating the intrusion scanning entity to scan the plurality of endpoints in the private network for indications of an intrusion from outside of the private network, and report any identified intrusion indication as intrusion scanning information to the intrusion notifying entity, and
operating the intrusion notifying entity to collect the intrusion scanning information for the plurality of endpoints in the private network from the intrusion scanning entity, and notify the collected intrusion scanning information to an operator of the private network or a security provider.

13. The method according to claim 12, wherein
the intrusion suspicion information comprises at least one indicator of compromise of a suspected intrusion in the private network and/or at least one rule for detection of a suspected intrusion in the private network, wherein the suspected intrusion is monitored by the endpoint security system.

14. The method according to claim 12, wherein
the intrusion scanning information comprises information on which one or more endpoints are compromised by the intrusion and/or information on which one or more kinds of compromise are used by the intrusion.

15. The method to according to claim 12, further comprising
creating the intrusion scanning entity and the intrusion notifying entity as client and server software packages, and/or
configuring the intrusion scanning entity and the intrusion notifying entity by running their build scripts using the intrusion suspicion information.

16. The method according to claim 12, wherein
the intrusion scanning entity and the intrusion notifying entity are uniquely created by a security provider on the basis of system information of the private network and/or the intrusion suspicion information.

17. The method according to claim 12, wherein
the intrusion scanning entity and the intrusion notifying entity are configured by an operator of the private network on the basis of the intrusion suspicion information.

18. The method according to claim 12, wherein
the intrusion scanning entity is deployed and operated as an agentless client in any one of the plurality of endpoints in the private network, and
the intrusion notifying entity is deployed and operated as a server in a dedicated host in the private network.

19. The method according to claim 18, wherein
the intrusion scanning entity is deployed in any endpoint at an arbitrary location in the endpoint, which is different from a standard location for installation of a security-related client or agent, and/or
the intrusion notifying entity is deployed in the dedicated host at an arbitrary location in the private network, which is different from a standard location for implementation of a security-related server.

20. The method according to claim 18, further comprising
verifying whether the intrusion scanning entity and/or the intrusion notifying entity is identified and/or flagged as malicious by the endpoint security system in the private network,
wherein the intrusion scanning entity and/or the intrusion notifying entity is deployed and operated upon verification that the intrusion scanning entity and/or the intrusion notifying entity is not identified and/or flagged as malicious by the endpoint security system in the private network.

21. The method according to claim 12, wherein
the intrusion scanning entity, after scanning and reporting, automatically deletes itself and cleans any indication of its presence from any one of the plurality of endpoints in the private network.

22. A non-transitory computer storage medium having stored thereon a computer program code for implementing the method of claim 12.
